(19) United States
(12) Patent Application Publication
(10) Pub. No.: US 2018/0147631 A1
(43) Pub. Date: May 31, 2018

(54) ALLOY POWDER MANUFACTURING DEVICE AND METHOD WITH TEMPERATURE CONTROL DESIGN

(71) Applicant: METAL INDUSTRIES RESEARCH & DEVELOPMENT CENTRE, Kaohsiung (TW)

(72) Inventors: Kuan-Yu CHEN, Kaohsiung (TW); Yang-Sheng HUANG, Kaohsiung (TW)

(73) Assignee: Metal Industries Research & Development Centre

(21) Appl. No.: 15/361,818

(22) Filed: Nov. 28, 2016

(51) Int. Cl. B22F 9/08; H05B 6/06; H05B 6/10

(52) U.S. Cl. CPC B22F 9/082; H05B 6/067; H05B 6/10; B22F 2009/0888; B22F 2009/0836; B22F 2009/0848; B22F 2009/0824

(57) ABSTRACT

An alloy powder manufacturing device with temperature control design includes: a crucible unit, for accommodating a melt; a melt delivery tube, for delivering the melt from the crucible unit; a temperature control unit, inductively heating the melt delivery tube and the melt therein, to generate an overtemperature melt, and enabling the temperature of the overtemperature melt leaving the melt delivery tube to reach a predetermined temperature; and a powder spray unit in communication with the outlet of the melt delivery tube, for impacting and atomizing the overtemperature melt having the predetermined temperature and then quickly solidifying the overtemperature melt to form alloy powders.

### BACKGROUND

### Technical Field

The present disclosure relates to an alloy powder manufacturing device and method, and particularly to an alloy powder manufacturing device and method with temperature control design which are suitable for delivering and reheating a melt.

### Related Art

Currently, Vacuum Induction-melting Gas Atomization (VIGA) can be used to manufacture alloy powders. Referring to FIG. 1, a conventional method of manufacturing alloy powders includes the follow steps of: first inductively heating an alloy material rod located inside a melting furnace 98 in a vacuum environment by using an induction coil 99, to melt the alloy material rod into a melt 91; then, pouring the melt 91 into a tundish 92; and finally, impacting and atomizing the melt 91 by a high-speed inert gas G and then quickly solidifying the melt 91 to form alloy powders P after the melt 91 passes through a melt delivery tube 93 and entering a nozzle 95 in a flow state.

However, the conventional method of manufacturing alloy powders does not utilize the design of reheating a melt, but only utilizes the melt delivery tube to be made of a material having a lower thermal conductivity, for example, Al₂O₃ or ZrO₂, to block heat loss. Therefore, the melt passing through the melt delivery tube still continues to cool, and then the temperature of the melt after cooling will directly affect the particle size and roundness of the alloy powders (in fact, if a dropwise melt is impacted and atomized by the high-speed inert gas, the quality of solidified titanium alloy powders will be affected). Moreover, a conventional process that the melt 91 flows through the nozzle outlet 95 to be subjected to the gas to form powders may last for a period of time. As the high-speed inert gas G acts on the outlet of the melt delivery tube 93, the ambient temperature thereof may be gradually cooled, leading to a problem of blocking of the outlet of the melt delivery tube 93 by the cooled melt. More seriously, cooling of the tip end of the outlet of the melt delivery tube 93 will interrupt the whole powder spray process.

In view of this, it is necessary to provide an alloy powder manufacturing device and method with temperature control design which are suitable for delivering and reheating a melt, to solve the foregoing problems.

### SUMMARY

A main objective of the present disclosure is to provide an alloy powder manufacturing device and method with temperature control design, to enable solidified alloy powders to have a reduced particle size and better roundness (spherical).

In order to achieve the foregoing objective, the present disclosure provides an alloy powder manufacturing device with temperature control design, including: a crucible unit, for accommodating a melt; a melt delivery tube including an inlet and an outlet, wherein the inlet is in communication with a bottom of the crucible unit, for delivering the melt from the crucible unit; a temperature control unit, including: an induction coil surrounding the melt delivery tube and used for inductively heating the melt delivery tube and the melt therein, to generate an overtemperature melt; a power-adjustable main machine, electrically connected to the induction coil and providing the power of the induction coil; a first temperature sensor, for measuring a temperature of the outlet of the melt delivery tube; and a microprocessor, electrically connected to the power-adjustable main machine and the first temperature sensor, wherein the microprocessor adjusts the power of the induction coil according to the temperature of the outlet of the melt delivery tube, to control the temperature of the outlet of the melt delivery tube, enabling the temperature of the overtemperature melt leaving the melt delivery tube to reach a predetermined temperature; and a powder spray unit in communication with the outlet of the melt delivery tube, for impacting and atomizing the overtemperature melt having the predetermined temperature and then quickly solidifying the overtemperature melt to form alloy powders.

The present disclosure utilizes an induction coil to conduct overtemperature control of the melt, enabling the temperature of the overtemperature melt entering the powder spray unit to reach a predetermined temperature, which can ensure and maintain the shape of the overtemperature melt and enable solidified alloy powders to have a reduced particle size and better roundness (spherical). Moreover, the present disclosure utilizes the induction coil to continuously heat the outlet of the melt delivery tube, which can overcome the problem of blocking of the outlet of the melt delivery tube by the conventional cooled melt.

To make the foregoing and other objectives, features, and advantages of the present disclosure more evident, detailed description is made hereinafter as follows with reference to the accompanying drawings.

### BRIEF DESCRIPTION OF THE DRAWINGS

FIG. 1 is a sectional schematic diagram of a conventional alloy powder manufacturing device;

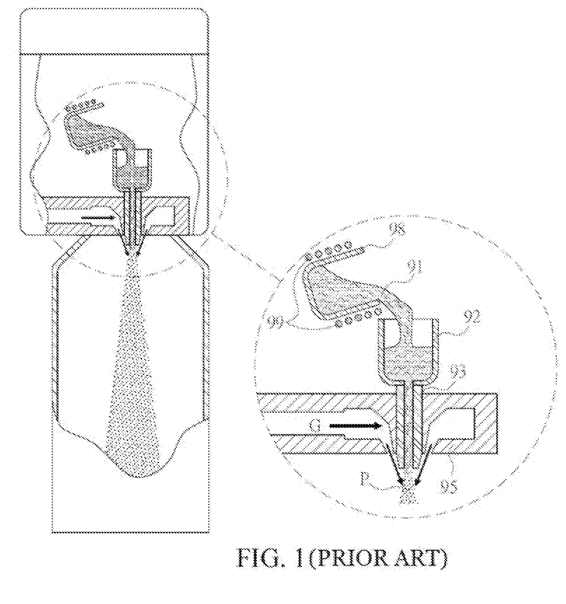

FIG. 2 is a sectional schematic diagram of an alloy powder manufacturing device with temperature control design of delivering and reheating a melt according to an embodiment of the present disclosure;

FIG. 3 is a sectional schematic diagram of an alloy powder manufacturing device with temperature control design of delivering and reheating a melt according to another embodiment of the present disclosure;

FIG. 4 is a sectional schematic diagram of a melt delivery tube and a powder spray unit according to an embodiment of the present disclosure; and

FIG. 5 is a flow chart of an alloy powder manufacturing method with temperature control design of delivering and reheating a melt according to the present disclosure.

### DETAILED DESCRIPTION

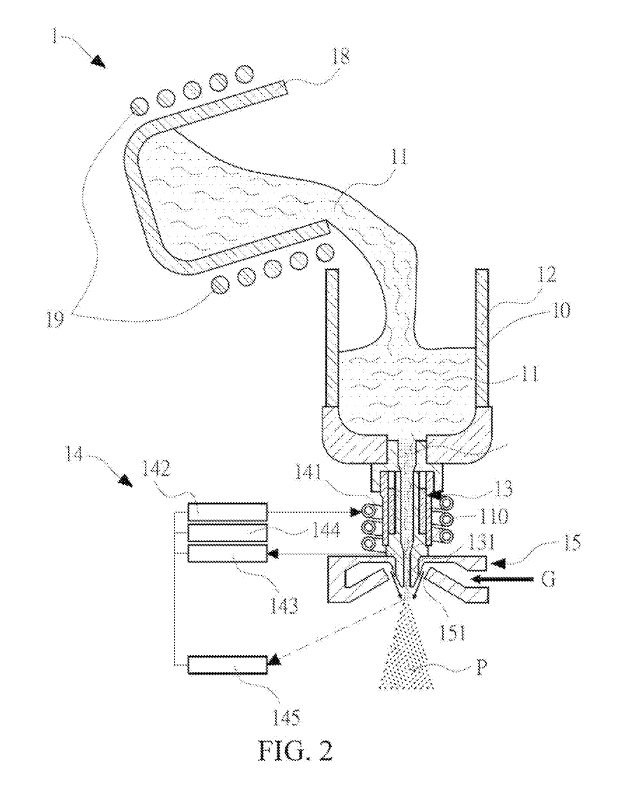

Referring to FIG. 2, it shows an alloy powder manufacturing device with temperature control design of delivering and reheating a melt according to an embodiment. In this embodiment, the alloy powders are described as below by using titanium alloy powders as an example.

The alloy powder manufacturing device 1 of the present disclosure includes: a crucible unit 10, a melt delivery tube (DT) 13, a temperature control unit 14, and a powder spray unit 15.

The crucible unit 10 is used for accommodating a melt 11. In this embodiment, the crucible unit 10 can be a tundish 12. A high frequency induction coil 19 (for example, 30 KW, 8 kHz) is used to inductively heat an alloy material rod (for example, a titanium alloy material rod) inside a melting furnace 18 in a vacuum environment, to melt the alloy material rod into the melt 11, and then the melt 11 is poured into the bearing crucible 12.

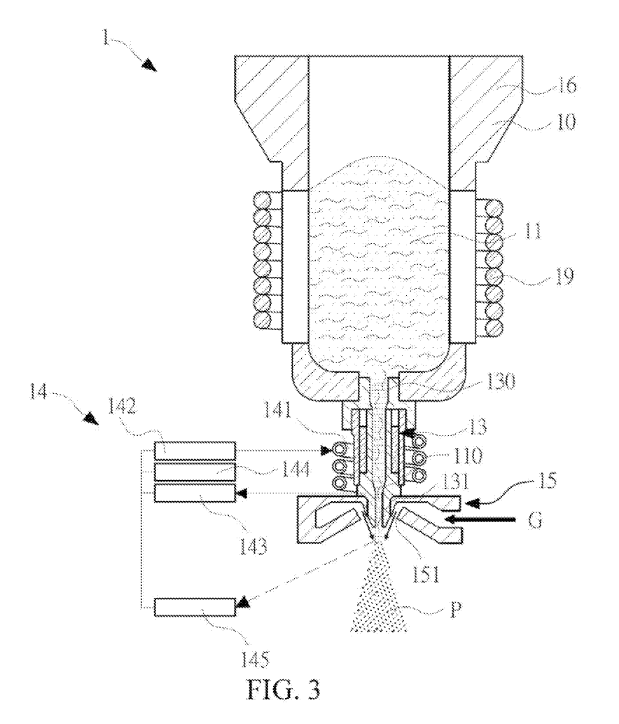

Referring to FIG. 3, in another embodiment, the crucible unit 10 can be a water-cooled copper crucible 16. The melt 11 of the crucible unit 10 can be generated by inductively heating an alloy material rod (for example, a titanium alloy material rod) by a high frequency induction coil 19 (for example, 30 KW, 8 kHz).

The melt delivery tube 13 includes an inlet 130 and an outlet 131, the inlet 130 being in communication with a bottom 101 of the crucible unit 10, for delivering the melt 11 of the crucible unit 10.

The temperature control unit 14 includes: an induction coil 141, a power-adjustable main machine 142, a first temperature sensor 143, and a microprocessor 144. The induction coil 141 surrounds the melt delivery tube 13, and is used for inductively heating the melt delivery tube 13 and the melt 11 therein, to generate an overtemperature melt 110. The power-adjustable main machine 142 is electrically connected to the induction coil 141 and provides the power of the induction coil 141. The first temperature sensor 143 is used for measuring a temperature of the outlet of the melt delivery tube 13. The first temperature sensor 143 can be a thermocouple temperature sensor. The microprocessor 144 is electrically connected to the power-adjustable main machine 142 and the first temperature sensor 143. The microprocessor 144 adjusts the power of the induction coil 141 according to the temperature of the outlet of the melt delivery tube 13, to control the temperature of the outlet of the melt delivery tube 13, enabling the temperature of the overtemperature melt 110 leaving the melt delivery tube 13 (the temperature of the overtemperature melt 110 can be calculated from the temperature of the outlet of the melt delivery tube 13) to reach a predetermined temperature. For example, if the power of the induction coil 110 is 50 KW, the temperature of the overtemperature melt 110 reaches 2000 degrees Celsius; if the power of the induction coil 110 is 30 KW, the temperature of the overtemperature melt 110 reaches 1900 degrees Celsius; or, if the power of the induction coil 110 is 10 KW, the temperature of the overtemperature melt 110 reaches 1800 degrees Celsius. The induction coil 141 is a high frequency coil, for example, 200 kHz. The microprocessor 144 can further include a proportional integral derivative (PID) controller, for outputting the power of the induction coil 141 according to the predetermined temperature, to inductively heat the melt delivery tube 13 and the overtemperature melt 110, enabling the temperature of the overtemperature melt 110 to reach the predetermined temperature.

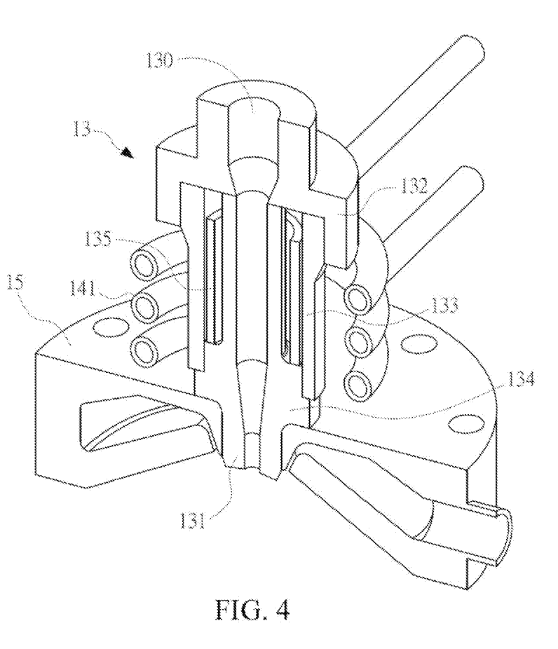

Referring to FIG. 4 and FIG. 2, the melt delivery tube 13 is a combined melt delivery tube, including an inlet portion 132, a connecting portion 133, an outlet portion 134, and an induction sleeve 135. The crucible unit 10, the inlet portion 132, the outlet portion 134, and the powder spray unit 15 are communicated with each other sequentially, the induction sleeve 135 is sheathed on the outlet portion 134, and the connecting portion 133 is screwed to the inlet portion 132 and the outlet portion 134, for securing the inlet portion 132, the connecting portion 133, the outlet portion 134, and the induction sleeve 135 together. The inlet portion 132, the connecting portion 133, and the outlet portion 134 of the melt delivery tube 13 can be made of a heat-resistant material of boron nitride, and the induction sleeve 135 can be made of a heat-resistant material such as graphite or tungsten steel, so as to increase efficiency of inductive heating.

Referring to FIG. 2 again, the powder spray unit 15 is in communication with the outlet 131 of the melt delivery tube 13, and includes a nozzle outlet 151 and a high speed inert gas G. The high speed inert gas G is used for, at the position of the nozzle outlet 151, impacting and atomizing the overtemperature melt 110 having the predetermined temperature and then quickly solidifying the overtemperature melt to form alloy powders P. For example, the overtemperature melt 110 enters the powder spray unit 15, such that the overtemperature melt 110 having the predetermined temperature is quickly solidified to form titanium alloy powders after being impacted and atomized by the high speed inert gas G (for example, argon). As the overtemperature melt 110 goes through overtemperature control, the rise in the temperature of the overtemperature melt 110 can cause reduction in viscosity of the overtemperature melt 110, enabling the solidified titanium alloy powders to have a reduced particle size and better roundness (spherical).

The temperature control unit 14 can further include a second temperature sensor 145, electrically connected to the microprocessor 144 and used for measuring a temperature of the nozzle outlet 151, so as to obtain a temperature distribution diagram of the overtemperature melt 110 after being impacted and atomized. The second temperature sensor 145 can be an infrared temperature sensor.

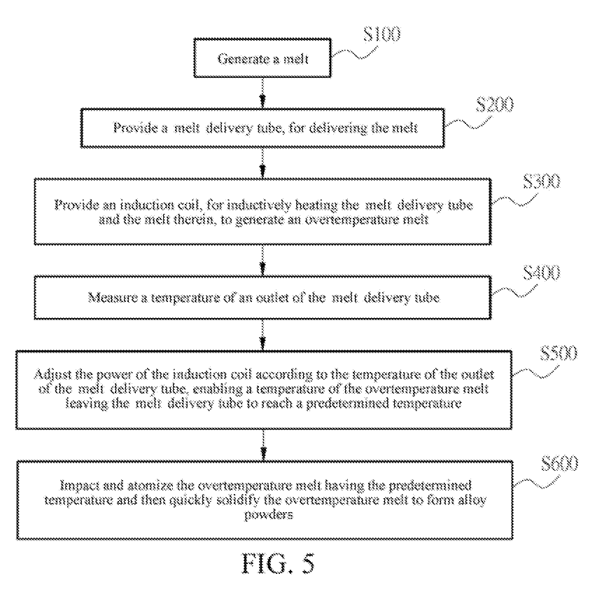

Referring to FIG. 5, in brief, the present disclosure provides an alloy powder manufacturing method with temperature control design of delivering and reheating a melt, including the following steps: in step S100, generating a melt; in step S200, providing a melt delivery tube, for delivering the melt; in step S300, providing an induction coil, for inductively heating the melt delivery tube and the melt therein, to generate an overtemperature melt; in step S400, measuring a temperature of an outlet of the melt delivery tube; in step S500, adjusting the power of the induction coil according to the temperature of the outlet of the melt delivery tube, to control the temperature of the outlet of the melt delivery tube, enabling a temperature of the overtemperature melt leaving the melt delivery tube to reach a predetermined temperature; and in step S600, impacting and atomizing the overtemperature melt having the predetermined temperature and then quickly solidifying the overtemperature melt to form alloy powders.

The present disclosure utilizes an induction coil to conduct overtemperature control of the melt, enabling the temperature of the overtemperature melt entering the powder spray unit to reach a predetermined temperature, which can ensure and maintain the shape of the overtemperature melt and enable solidified alloy powder to have a reduced particle size and better roundness (spherical). Moreover, the present disclosure utilizes the induction coil to continuously heat the outlet of the melt delivery tube, which can overcome the problem of blocking of the outlet of the melt delivery tube by the conventional cooled melt.

The above merely describes implementations or embodiments of technical means employed by the present disclosure to solve the technical problems, which are not intended to limit the patent implementation scope of the present disclosure. Equivalent changes and modifications in line with the meaning of the patent scope of the present disclosure or made according to the scope of the invention patent are all encompassed in the patent scope of the present disclosure.

What is claimed is:

1. An alloy powder manufacturing device with temperature control design, the alloy powder manufacturing device comprising:
a crucible unit, for accommodating a melt;
a melt delivery tube comprising an inlet and an outlet, wherein the inlet is in communication with a bottom of the crucible unit, for delivering the melt from the crucible unit;
a temperature control unit, comprising:
an induction coil surrounding the melt delivery tube and used for inductively heating the melt delivery tube and the melt therein, to generate an overtemperature melt;
a power-adjustable main machine, electrically connected to the induction coil and providing the power of the induction coil;
a first temperature sensor, for measuring a temperature of the outlet of the melt delivery tube; and
a microprocessor, electrically connected to the power-adjustable main machine and the first temperature sensor, wherein the microprocessor adjusts the power of the induction coil according to a temperature of the outlet of the melt delivery tube, to control the temperature of the outlet of the melt delivery tube, enabling a temperature of the overtemperature melt leaving the melt delivery tube to reach a predetermined temperature; and
a powder spray unit in communication with the outlet of the melt delivery tube, for impacting and atomizing the overtemperature melt having the predetermined temperature and then quickly solidifying the overtemperature melt to form alloy powders.

2. The alloy powder manufacturing device with temperature control design according to claim 1, wherein the temperature control unit further comprises a second temperature sensor, electrically connected to the microprocessor and used for measuring a temperature of a nozzle outlet.

3. The alloy powder manufacturing device with temperature control design according to claim 2, wherein the second temperature sensor is an infrared temperature sensor.

4. The alloy powder manufacturing device with temperature control design according to claim 1, wherein the first temperature sensor is a thermocouple temperature sensor.

5. The alloy powder manufacturing device with temperature control design according to claim 1, wherein the melt delivery tube is a combined melt delivery tube, comprising an inlet portion, a connecting portion, an outlet portion and an induction sleeve, the crucible unit, the inlet portion, the outlet portion and the powder spray unit are communicated with each other sequentially, the induction sleeve is sheathed on the outlet portion, and the connecting portion is screwed to the inlet portion and the outlet portion, for securing the inlet portion, the connecting portion, the outlet portion and the induction sleeve together.

6. The alloy powder manufacturing device with temperature control design according to claim 5, wherein the induction sleeve is made of a heat-resistant material of graphite or tungsten steel.

7. The alloy powder manufacturing device with temperature control design according to claim 6, wherein the inlet portion, the connecting portion, and the outlet portion are made of a heat-resistant material of boron nitride.

8. The alloy powder manufacturing device with temperature control design according to claim 1, wherein the crucible unit is a tundish or a water-cooled copper crucible.

9. The alloy powder manufacturing device with temperature control design according to claim 1, wherein the microprocessor further comprises a proportional integral derivative controller, for outputting the power of the induction coil according to the predetermined temperature, to inductively heat the melt delivery tube and the overtemperature melt, enabling the temperature of the overtemperature melt to reach the predetermined temperature.

10. An alloy powder manufacturing method with temperature control design, alloy the powder manufacturing method comprising the following steps of:
generating a melt;
providing a melt delivery tube, for delivering the melt;
providing an induction coil, for inductively heating the melt delivery tube and the melt therein, to generate an overtemperature melt;
measuring a temperature of an outlet of the melt delivery tube;
adjusting a power of the induction coil according to a temperature of the outlet of the melt delivery tube, to control the temperature of the outlet of the melt delivery tube, enabling a temperature of the overtemperature melt leaving the melt delivery tube to reach a predetermined temperature; and
impacting and atomizing the overtemperature melt having the predetermined temperature and then quickly solidifying the overtemperature melt to form alloy powders.
